(19) United States
(12) Patent Application Publication
(10) Pub. No.: US 2014/0114722 A1
(43) Pub. Date: Apr. 24, 2014

(54) Method and Apparatus For Ranking a Customer Based on The Customer's Estimated Influence on Other Customers and The Customer's Churn Score

(71) Applicant: TELEFONAKTIEBOLAGET L M ERICSSON (PUBL), Stockholm (SE)

(72) Inventors: Saravanan MOHAN, Chennai (IN); Vijay Raajaa Sundara Raja Moorthy, Madurai (IN)

(73) Assignee: Telefonaktiebolaget L M Ericsson (publ), Stockholm (SE)

(21) Appl. No.: 13/658,924

(22) Filed: Oct. 24, 2012

(51) Int. Cl. G06Q 30/02

(52) U.S. Cl. CPC G06Q 30/0201
USPC 705/7.29

(57) ABSTRACT

A method is disclosed wherein churn scores and influence scores for each customer in a particular set of customers (the set may include all customers of the network or some subset of all the customers) is determined. Each customer in the set can be ranked based on the customer's churn score and influence score. For example, a customer with a low churn score and a low influence score would be ranked lower than a customer with a high churn score and a high influence score. The customers that are ranked the highest should be the target of a retention campaign on a timely manner.

### TECHNICAL FIELD

The present disclosure relates to systems and method for ranking customers based on the customer's estimated influence in a network and the customer's churn score.

### BACKGROUND

Churn refers generally to the movement of customers from one service provider to another. As used herein a “churner” is customer of a service that unsubscribes to the service or otherwise ceases using the service. Churn is a serious problem in many industries, including the telecom industry. It is a significant problem because customer churn leads to diminished profits for the telecom operator and, perhaps, increased business for a competitor. Moreover, in some aspects, it is more important for a telecom operator to retain its existing customers than to sign-up new customers (i.e., existing customers may be more profitable than new customers given the costs involved in attracting new customers). With the continuous addition of new telecom operators in the market, and with the availability of mobile number portability service, churners are increasing at an alarming rate. Hence, telecom operators would like to identify potential churners so that improved services or other incentives may be offered to these customers in an effort to retain them.

What is desired is a system and method for determining customers to whom incentives should be offered to reduce the probability of the customer becoming a churner.

### SUMMARY

In order to address at least some of the above issues, there is a need for improved methods and system for predicting whether a given customer is likely to become a churner (i.e., quit using the service) in some future period of time (e.g., the next week, month or quarter). Such improved methods and system are disclosed in U.S. patent application Ser. No. 13/495,667, filed Jun. 13, 2012, which is incorporated by reference herein in its entirety. There is also a need for determining the influence a customer may have on other customers. For example, it may be wise to offer some sort of incentive to a customer who has been identified has having (a) high a probability of becoming a churner and (b) a high degree of influence over other customers such that, if the customer were to leave the network, then there would be a high probability that this action would greatly influence other customers to leave the network.

Disclosed herein are such improved methods and systems. This disclosure, for example, discloses a method that uses graph parameter analysis to predict whether a customer of a service will be a churner (e.g., to categorize a customer as a churner or a non-churner) and to estimate the influence of that customer. The disclosure is applicable to the telecom industry as well as other industries, such as: Internet service providers, cable TV providers, insurance firms, alarm monitoring services, etc.

In this disclosure, telecom data is visualized in the form of a call graph and several call graph parameters are deduced from the graph. In some embodiments, such call graph parameters include: In-Degree, Out-Degree, Closeness centrality, Call weight, Proximity prestige, Eccentricity centrality, and Clustering coefficient, In Degree prestige, Out degree prestige, and Shapley value. These graph parameters indicate the active participation of a customer with respect to the service and thus aids in studying churn and influence behavior over a period of time.

Tasks that may be carried out to determine those customers to whom incentives should be offered include:

1. Determine churn scores for each customer in a given set of customers based on graph parameter variations

2. Determine an influence score for probable churners.

3. Adjust a customer's churn score based on the influence score of the neighbouring customers. The scores are adjusted because there is good chance that a neighbour may influence the customer to churn out.

4. Further adjust the churn probability score based on the influence of the neighbouring nodes who have already left the network.

5. Determine influential spreaders from the influential churners in the network based on the influence weight and the number of connections made by a given node.

6. Rank the probable churners using a ranking matrix.

7. Output the ranked list of churners. The telecom operators may then choose the target audience to launch retention campaigns.

In one particular aspect there is provided a particular method for determining a set of customers of a network operator to which a retention campaign should be directed. According to some embodiments, the method includes: determining a churn score for a first customer of the network operator (the churn score is a value corresponding to a probability of the first customer churning out of the network); determining an influence score for the first customer (the influence score is a value representing an estimated influence exerted by the first customer on one or more other customers of the network operator); and assigning a rank to the first customer based on the determined influence score and the determined churn score.

In some embodiments, the method further comprises determining an influence score for one or more neighbors of the first customer; and the step of determining the churn score for the first customer comprises: determining an initial churn score for the first customer and adjusting the initial churn score based on the influence scores for the one or more neighbors. The step of adjusting the initial churn score based on the influence scores for the one or more neighbors may include: determining if the influence score for a neighbor of the first customer exceeds a first threshold; and in response to determining that the influence score for the neighbor of the first customer exceeds the first threshold, adjusting the first customer's initial churn score.

In some embodiments, the method further comprises determining whether the customer had a neighbor that recently churned out of the network, and the step of determining the churn score for the first customer comprises: determining an initial churn score for the first customer and adjusting the initial churn score in consequence of determining that the customer had a neighbor that recently churned out of the network.

In some embodiments, the step of determining the churn score for the first customer comprises: obtaining first call data for the first customer; using the first call data to determine a value (v1) for a graph parameter for the first customer, the graph parameter being one of: (a) an out-degree parameter, (b) a Shapley Value parameter, (c) a proximity prestige parameter, and (d) closeness centrality parameter; and using the determined value (v1) to determine the churn score. The method may further include: obtaining second call data for the first customer, the second call data identifying communications from the first customer that were made during a second period of time, wherein the first call data for the first customer identifies communications from the first customer that were made during a first period of time; using the second call data to determine a value (v2) for the graph parameter; and using the determined values v1 and v2 to determine the churn score. The step of using the determined values v1 and v2 to determine the churn score may include calculating c1*(v2−v1), wherein c1 is a predetermined constant.

In some embodiments, the step of determining the influence score for the first customer comprises: determining an initial influence score for the first customer; determining whether the first customer is a potential spreader; and adjusting the initial influence score in consequence of determining that the first customer is a potential spreader.

In some embodiments, the method also includes: determining whether the rank assigned to the first customer exceeds a rank threshold; and in consequence of determining that the rank assigned to the first customer exceeds the rank threshold, taking an action to reduce the probability that the first customer will churn out of the network within a period of time. The step of taking an action to reduce the probability may include offering to the first customer an incentive for the first customer to remain a customer of the network operator at least during the period of time.

Disclosed herein is also a computer program product, which may be in the form of a non-transitory memory and which comprises a computer program. The computer program comprises code which when run on the system, causes the system to perform a method according to any embodiment disclosed herein.

Other aspects, embodiments, and features are described below.

### BRIEF DESCRIPTION OF DRAWINGS

Embodiments will now be described in more detail in relation to the accompanying drawings, in which:

FIG. 1 illustrates an example call graph created from call data pertaining to a first period of time.

FIG. 2 illustrates an example call graph created from call data for a second period of time.

FIG. 3 illustrates an example call graph created from call data for a third period of time.

FIG. 4 is a flow chart illustrating a process according to some embodiments.

FIG. 5 is a flow chart illustrating a process, according to some embodiments, for determining a churn score.

FIG. 6 is a flow chart illustrating a process, according to some embodiments, for determining an influence score.

FIG. 7 is a flowchart illustrating a method for categorizing a customer as a churner or non-churner according to an exemplifying embodiment.

FIG. 8 is a flowchart illustrating a method for categorizing a customer as a churner or non-churner according to an exemplifying embodiment.

FIG. 9 illustrates an example call graph and an example degree centrality table created based on the information contained in the call graph.

FIG. 10 illustrates a process, according to some embodiments for determining an influence score.

FIG. 11 shows an example ranking matrix, according to some embodiments.

FIG. 12 is a block diagram illustrating a data processing apparatus according to an exemplifying embodiment.

### DETAILED DESCRIPTION

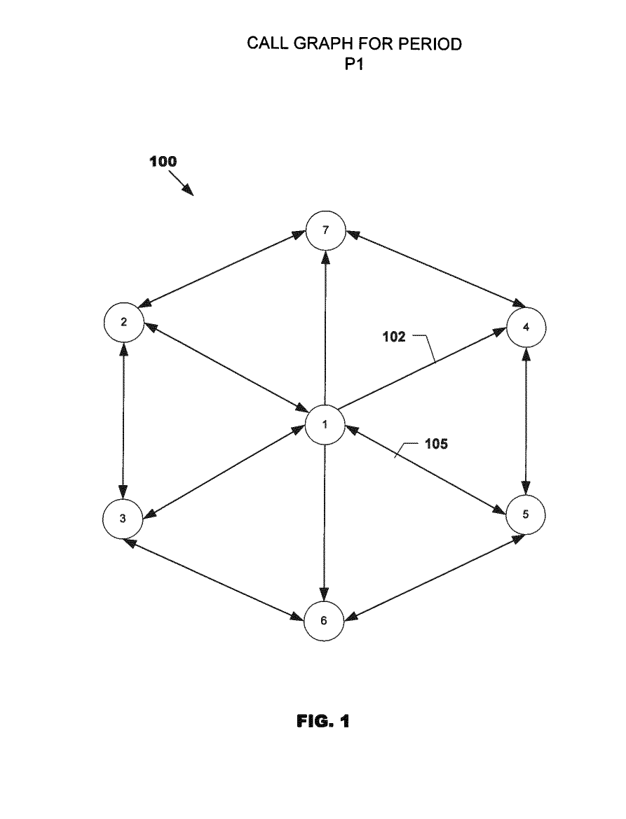

FIG. 1 illustrates an example call graph 100 created from call data (e.g., CDRs) pertaining to a particular telecom service and pertaining to a particular period of time (P1). P1 may be a day, a week, a month or some other period. At least some of the nodes (a.k.a, “vertices”) of the call graph 100 represent a customer of the telecom service. For example, nodes 2 and 5 may each represent a different customer of the telecom service. The edges of the graph (i.e., the lines connecting the nodes) represent communications between customers. More specifically, a line connecting a first node with a second node and having only a single arrow at one end represents that the customer associated with one of the nodes has initiated a communication (phone call, text message, e-mail) to the other customer associated with the other node, and represents that the other customer has not initiated any communications to the first customer. For example, edge 102 indicates that the customer associated with node 1 (“customer 1”) has, within the period P1, initiated at least one communication to customer 4, but customer 4 has not, within the period P1, initiated any communication to customer 1. As another example, edge 105 indicates that customer 1 has, within the period P1, initiated at least one communication to customer 5, and customer 5 has, within the period P1, initiated at least one communication to customer 1.

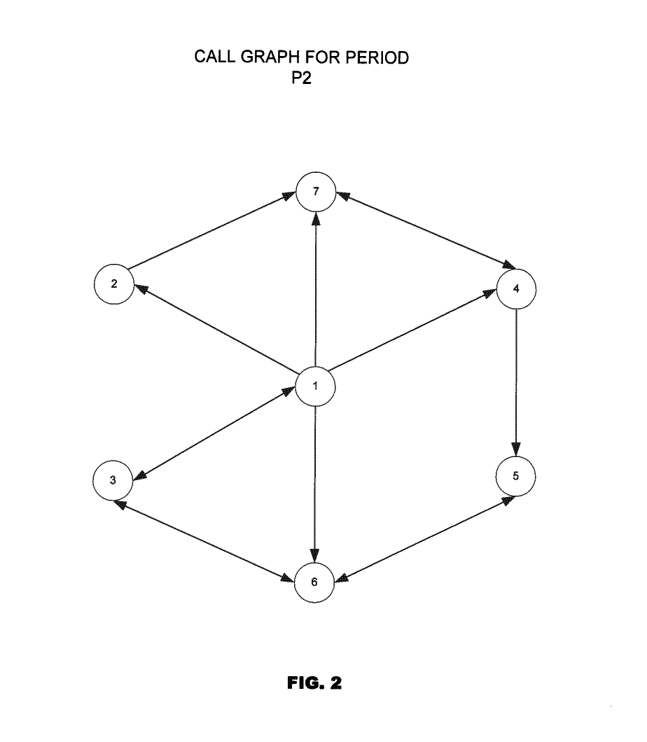

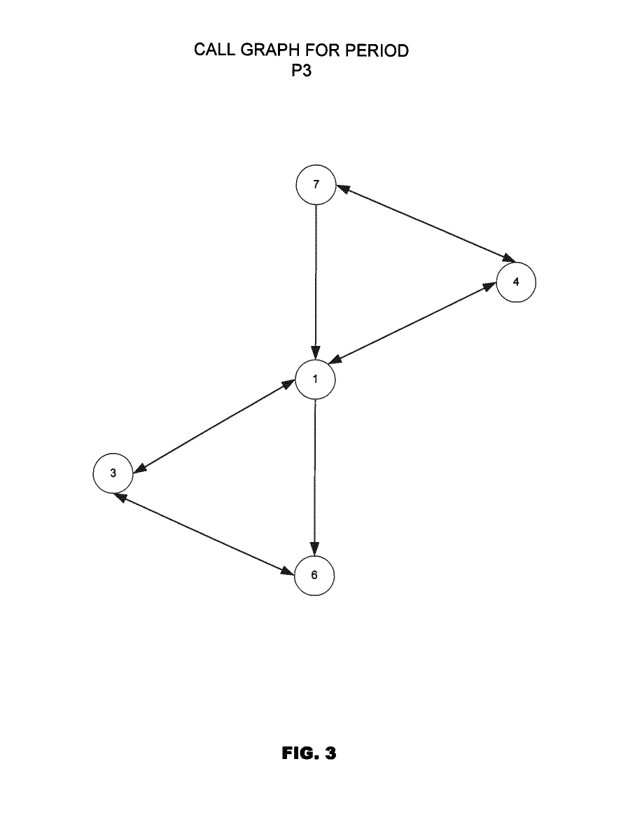

FIG. 2 illustrates an example call graph 200 created from call data pertaining to the telecom service and pertaining to a period of time (P2). In this example, P2 immediately follows P1. Likewise, FIG. 3 illustrates an example call graph 300 created from call data pertaining to the telecom service and pertaining to a period of time (P3), which immediately follows P2.

As illustrated in FIG. 2 and FIG. 3, at least a portion of the call graph for the telecom service changes over time, as one would expect. For example, FIG. 1 shows that in period P1, customer 2 and customer 3 communicated with each other using the telecom service, but FIG. 2 shows that, customer 2 and customer 3 did not communicate with each other using the telecom service during period P2. FIG. 3, shows that, sometime during period P3, customers 2 and 5 churned (i.e., quit the service).

According to embodiments of this disclosure, changes in a call graph from one period to the next are analyzed to predict which, if any, of the customers represented in the call graph will churn in the subsequent period. For example, in some embodiments, parameters of a call graph (i.e., “call graph parameters” or “graph parameters”) for each customer in a set of customers are determined from one period to the next, and these determined graph parameters for the customer are used to predict whether the user will be a churner in the next period (i.e., they are used to categorize the user as a churner or a non-churner). For example, the determined graph parameters may be used to determine a “churn score” for each customer in the set, where the churn score is value that represents the likelihood that the customer will churn. The churn score for any given user may be binary value (e.g., “likely churner” vs. “unlikely chuner”). In some embodiments, one or more of the following graph parameters are determined and used to determine churn scores: In-Degree, Out-Degree, Degree prestige (DP), Closeness Centrality (CC), Proximity prestige (PP), Eccentricity centrality (EC), Clustering coefficient, and Call weight (CW). Additionally, in some embodiments, a Shapely value as well as other parameters may also be determined.

The In-degree parameter measures the number of incoming connections to a given user. To measure the in-degree of a given user (vᵢ) we count the number of unique users who have initiated a communication with the given user.

The Out-degree parameter measures the number of outgoing connections from a given user (vi). We find the measure by counting the number of unique users to whom the given user has initiated a communication.

The Degree Prestige (DP) parameter is based on the In-degree and Out-degree parameter values, which takes into account the number of members adjacent to a particular node in the network. More prominent members can be found using this factor. In some embodiments, DP for a given customer (i) (i.e., DPᵢ) equals:

$${DP}_{i} = \frac{{f}_{i}}{\vert V \vert - 1}$$

where fᵢ is the number of first level neighbours adjacent to node vᵢ.

The Closeness centrality (CC) parameter measures the importance of a user based on their “location” in the call graph. A central user will tend to have high closeness centrality; i.e. if the call graph was thought of an information passing network, then rumors initiated by a central user will spread to the whole network quicker. In some embodiments, CC for a given user (vᵢ) equals 1/lᵢ, where lᵢ equals:

$${l}_{i} = \frac{1}{\vert V \vert} {\sum }_{j ∈ v}^{ } {d}_{i , j}$$

Where d_{i,j} is the length of the shortest path between vertex vᵢ and vertex vⱼ.

The Proximity Prestige (PP) parameter reflects how close all members are present with respect to node x in the network. In some embodiments, PP equals:

$${PP}_{i} = \frac{\frac{{k}_{i}}{\vert V \vert - 1}}{\frac{1}{{k}_{i}} {\sum }_{j = 1 , j ∈ V}^{{k}_{i}} {d}_{i , j}}$$

where kᵢ is the number of nodes in the network who can reach member vi

The Eccentricity Centrality (EC) parameter states the most central node in the network. It signifies that the node with high eccentricity minimizes the maximum distance to any other node in the network. EC is represented as:

$$EC ( x ) = \frac{1}{max \{ {d}_{i , j} \text{:} j ∈ V \}}$$

The Clustering Coefficient (CLC) represents the community density formed by a given node in the network. When a customer from a highly clustered community is likely to churn then there is a possibility that he will induce other members in the community to churn as well. It is represented as:

$$CLCi = \frac{2 \vert \{ {e}_{jk} \} \vert}{{k}_{i} ( {k}_{i} - 1 )} \text{:} {v}_{j} , {v}_{k} ∈ V , {e}_{jk} ∈ E$$

where, eⱼₖ is the number of edges

The Call Weight (CW) parameter refers to the level of participation of a user in the network. If the level of participation decreases over a period of time, then it indicates that the user is not interested in the network and may churn out.

The Shapley value represents the influential score for a given node in the network Influential nodes are the one who are not only active in participation but also holds strong influence among their neighbouring nodes. The telecom carriers must target the influential churners with their retention scheme first to prevent them from becoming an influential churn spreader. It is represented as:

$${SV}_{i} = {\sum }_{{v}_{j} ∈ V ⋃ N ( {v}_{j} , d )}^{ } \frac{1}{1 + deg ( {v}_{j} )}$$

where N(vⱼ,d) represents neighbouring nodes with d degree of separation from node vᵢ.

In addition to using graph parameters to determine churn scores (e.g., categorizing a customer as a “likely churner” or “unlikely churner”), one or more graph parameters may be used to determine a customer's “influence score”-—the influence that the customer has on other customers. After determining the churn scores and influence scores for each customer in a particular set of customers (the set may include all customers of the network or some subset of all the customers), then each customer in the set can be ranked based on the customer's churn score and influence score. For example, a customer with a low churn score and a low influence score would be ranked lower than a customer with a high churn score and a high influence score. The customers that are ranked the highest should be the target of a retention campaign.

The table below, Table 1, illustrates example graph parameter values for customer 2 for periods P1 and P2. A similar table may be created for each other customer. For example, Table 2 illustrates example graph parameter values for customer 1 for periods P1, P2 and P3.

TABLE 1
(Customer 2)

| Graph Parameters | Week 1 | Week 2 |
|---|---|---|
| In-Degree | 3 | 2 |
| Out-Degree | 3 | 1 |
| InDegree-Prestige | 0.4285714 | 0.2857142 |
| OutDegree-Prestige | 0.4285714 | 0.14285714 |
| Closeness Prestige | 0.1111111 | 0.1666666 |
| Proximity Prestige | 0.5714285 | 0.2142857 |
| Eccentricity Centrality | 0.5 | 0.3333333 |
| Clustering Coefficient | 0.2 | 0.0 |
| Shapely Value | 0.023 | 0.5 |

TABLE 2
(Customer 1)

| Graph Parameters | Week 1 | Week 2 | Week 3 |
|---|---|---|---|
| In-Degree | 3 | 1 | 1 |
| Out-Degree | 6 | 5 | 4 |
| InDegree-Prestige | 0.4385714 | 0.1428571 | 0.2 |
| OutDegree-Prestige | 0.8571428 | 0.7142857 | 0.8 |
| Closeness Prestige | 0.1666666 | 0.4285714 | 0.25 |
| Proximity Prestige | 0.8571428 | 0.73469387 | 0.8 |
| Eccentricity Centrality | 1.0 | 0.5 | 1.0 |
| Clustering Coefficient | 0.3333333 | 0.4 | 0.4 |
| Shapely Value | 0.023 | 0.058 | 0.055 |

As illustrated in the Table 1, some of the graph parameter values, which are generated from the call data, changed significantly from period P1 to period P2. This is because there is a correlation between changes in one or more of a customer's graph parameters over time and whether or not the customer will churn.

To formalize this correlation and produce a model for determining churn scores using call graph parameters we have an analysed a large set of historical CDRs spanning multiple periods and have determined the following model for determining a churn score (CS) for a customer, however, the invention is not limited to this or any specific model:

CS=−4.718+2.267(CC2−CC1)−0.510(OD2−OD1)+1.546(PP2−PP1)−1.22(SV2−SV1),

where CC1 and CC2 are first and second CC parameter values for a particular user. Like CC1 and CC2, OD1, OD2, PP1, PP2, SV1, and SV2 are first and second OD, PP and SV parameter values for the particular user, respectively. Whether the user is categorized as a churner or non-churner depends on the value of CS. For example, the user may be categorized as a churner when CS equals 1.

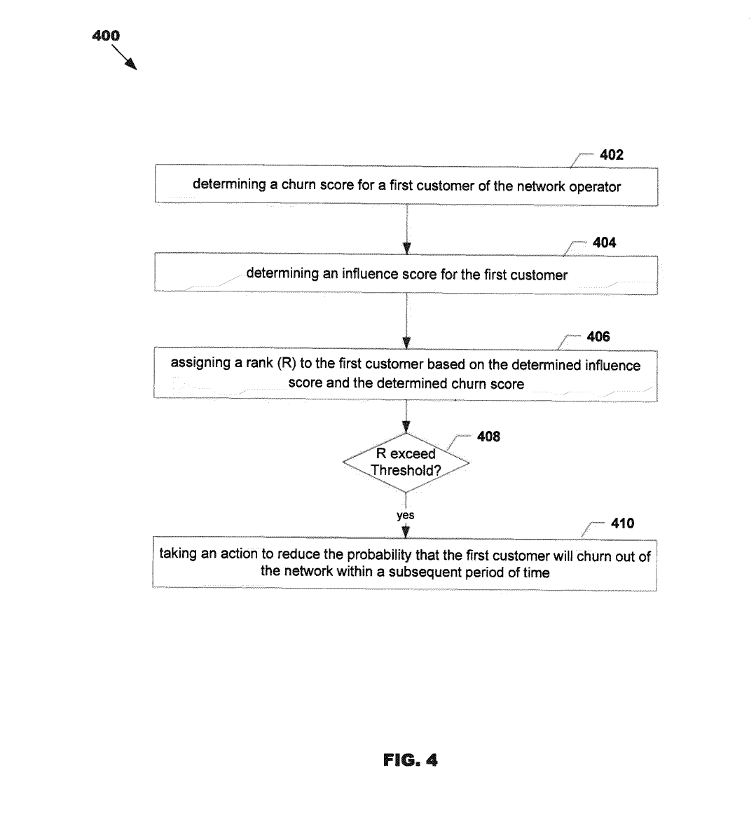

Referring now to FIG. 4, FIG. 4 is a flow chart illustrating a process 400, according to some embodiments of this disclosure, for determining a subset of customers, from a given set of customers (e.g., all customers of the network operator or any subset thereof), to whom a retention scheme should be applied (e.g., to whom a particular incentive offer should be made).

As illustrated in FIG. 4, process 400 includes the following steps: determining a chum score for a first customer of the network operator (step 402); determining an influence score for the first customer (step 404), wherein the influence score is a value representing an estimated influence exerted by the first customer on one or more other customers of the network operator; assigning a rank (R) to the first customer based on the determined influence score and the determined churn score (step 406); determining whether the assigned rank exceeds a rank threshold (step 408); and taking an particular action to reduce the probability that the first customer will chum out of the network within a subsequent period of time in consequence of determining that the assigned rank exceeds the rank threshold (step 410). Process 400 is preferably repeated for each customer included in a particular set of customers. The rank threshold may be set by the network operator based on any one or more of a number of factors, such as the prevailing conditions including, for example, the current required situation of the services provided by the network operator to the customer.

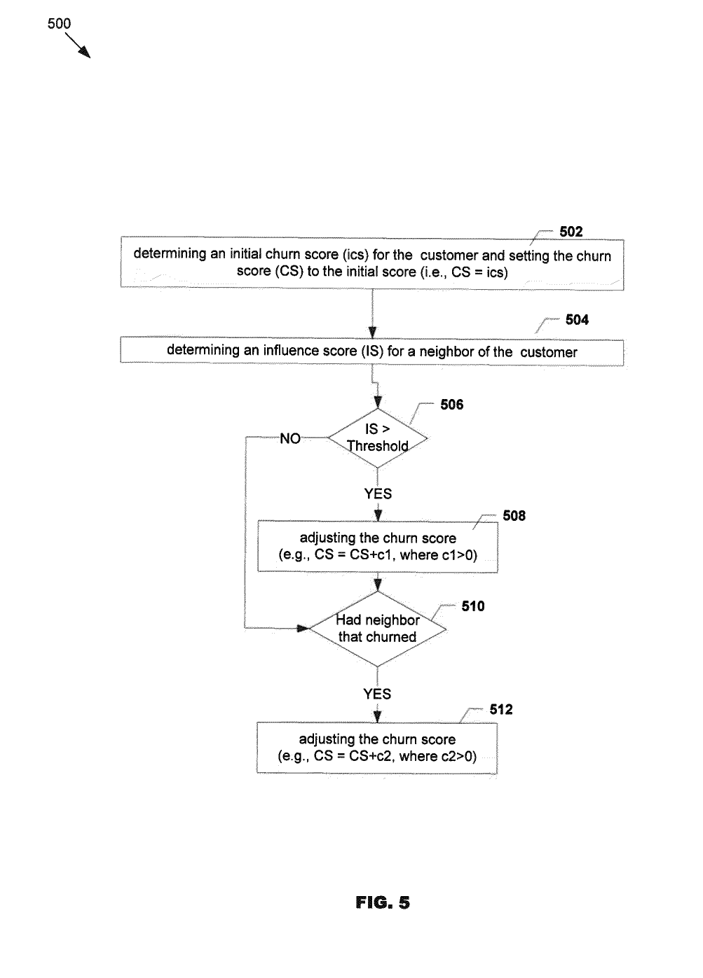

Referring now to FIG. 5, FIG. 5 is a flow chart illustrating a process 500, according to some embodiments of this disclosure, for determining a churn score (CS) for a customer (e.g., for performing step 402).

As illustrated in FIG. 5, process 500 includes: determining an initial churn score (ics) for the customer and setting CS equal to ics (step 502); determining an influence score (IS) for a neighbour of the customer (step 504); determining whether the determined IS exceeds a particular influence threshold (step 506); adjusting (e.g., increasing) the churn score in consequence of determining that the IS exceeds the influence threshold (step 508) (steps 504-508 may be iterated such that the steps are performed for each neighbour of the customer); determining whether the customer had a neighbour that recently churned out of the network (step 510); and adjusting (e.g., increasing) the churn score in consequence of determining that the customer had a neighbour that recently churned out of the network (step 512). The influence threshold may be set by the network operate based on any one or more of a number of factors, such as the prevailing conditions including, for example, the current required situation of the services provided by the network operator to the customer.

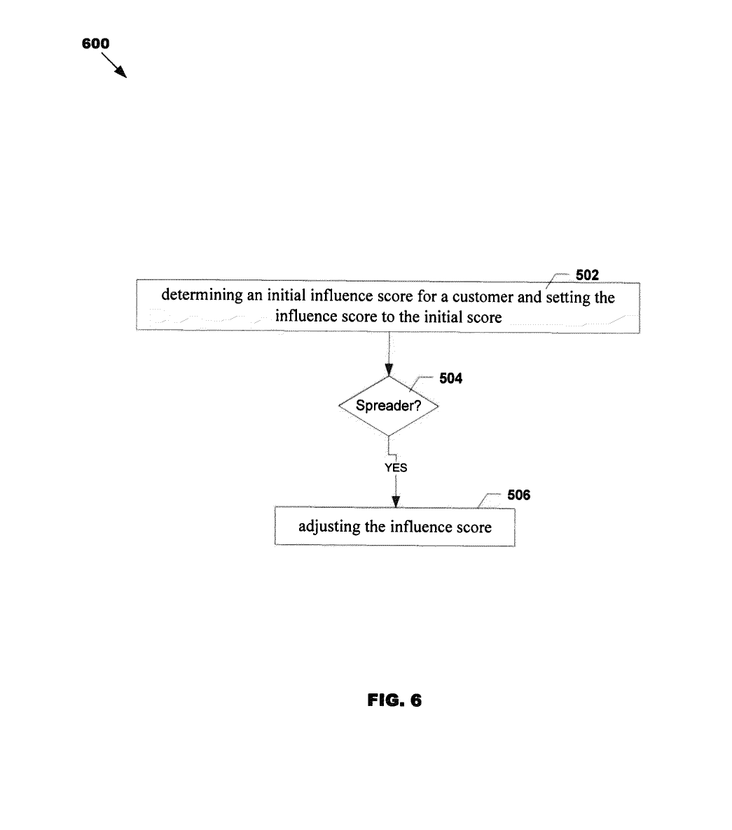

Referring now to FIG. 6, FIG. 6 is a flow chart illustrating a process 600, according to some embodiments of this disclosure, for determining an influence score for a customer.

As illustrated in FIG. 6, process 600 includes: determining an initial influence score for the customer and setting the influence score to the initial influence score (step 502); determining whether the customer is a spread (step 504) (e.g., determining whether the Shapley Value for the customer exceeds some predetermined threshold, which threshold may be set by the network operator based on any of a number of factors); and adjusting the influence score in consequence of determining that the customer is a spreader.

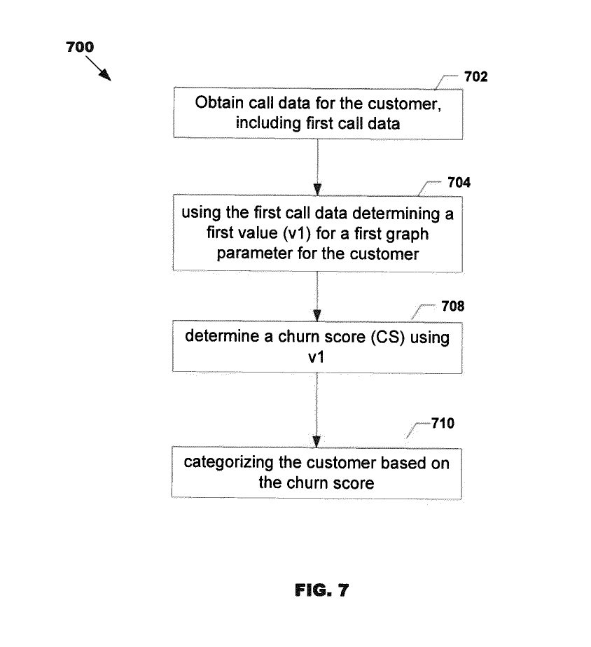

Referring now to FIG. 7, FIG. 7 illustrates a process 700 for determining an initial churn score for a customer. Process 700 may begin in step 702, in which call data is obtained for the customer. The call data may include a first set of call data.

In step 704, the first set of call data is used to determine a value (v1) for a graph parameter for the customer, the graph parameter being one of any of the graph parameters mentioned above. In some embodiments, the graph parameter is one of the following graph parameters: (a) an out-degree (OD) parameter, (b) a Shapley Value (SV) parameter, (c) a proximity prestige (PP) parameter, and (d) closeness centrality (CC) parameter.

In step 708, value v1 is used to determine a churn score (CS) for the customer. For example, in step 706, CS may be determined by inputting value vl into a model (as described above).

In step 710, the customer is categorized based on the churn score. For instance, the customer may be categorized as “churner” or as “non-churner” based on said churn score. A customer characterized as a “non-churner” is estimated to have a lower probability of churning out of the network than a customer characterized as a “churner.” As another example, the customer (or churn score) may be categorized as: low, moderate, or high. For example, a customer having a churn score categorized as “low” is estimated to have a lower probability of churning out of the network than a customer having a churn score categorized as “medium.” Likewise, a customer having a churn score categorized as “medium” is estimated to have a lower probability of churning out of the network than a customer having a churn score categorized as “high.”

In some embodiments, the model has the following form:

Y=−4.718+2.267(CC2−CC1)−0.510(OD2−OD1)+1.546(PP2−PP1)−1.22(SV2−SV1),

where CC1 and CC2 are first and second CC parameter values for a particular customer. Like CC1 and CC2, OD1, OD2, PP1, PP2, SV1, and SV2 are first and second OD, PP and SV parameter values for the particular customer, respectively. Whether the customer is categorized as a churner or non-churner depends on the value of Y. For example, The customer may be categorized as a churner when Y=1 and a non-churner when Y=0.

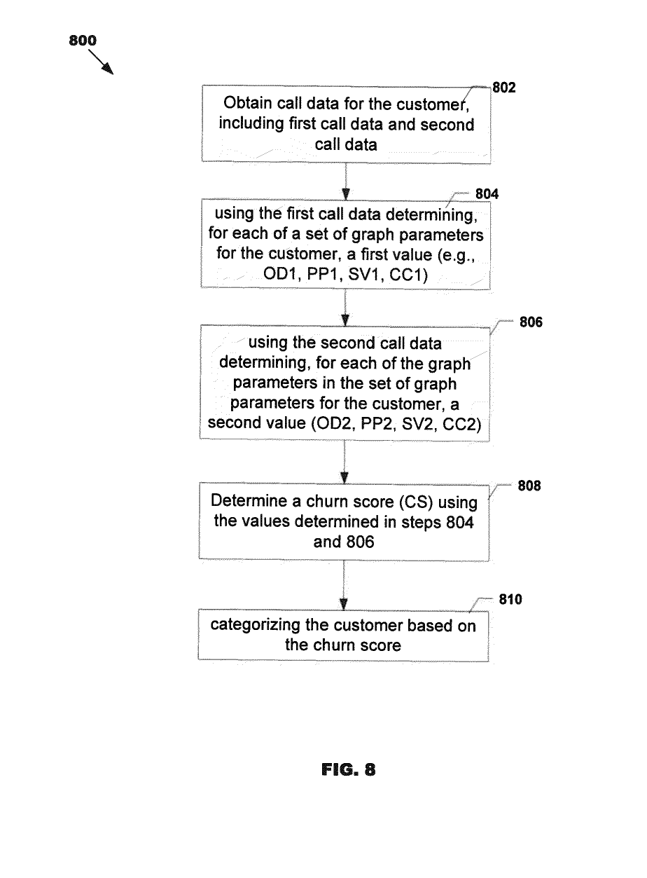

Because in some embodiments Y is a function of first and second values for several graph parameters, process 700 may be extended, as shown in FIG. 8.

FIG. 8 illustrates a process 800. Process 800 may begin in step 802, in which call data is obtained for the customer. The call data may include a first set of call data and a second set of call data for a set of customers.

The first set of call data may consist of CDRs for the customers for a first period of time (P1) and the second set of call data may consist of CDRs for the customers for a second period of time (P2). P2 may immediately follow P1. P1 and P2 may be a week or other period of time.

The first and second sets of call data contain a sufficient amount of call data (e.g., a sufficient number of CDRs) such that a first call graph (see e.g., FIG. 1) can be created from the first set of call data and a second call graph (see e.g., FIG. 2) can be created from the second set of call data. Additionally, the first and second call graphs contain a sufficient amount of information such that a first set of call graph parameters values for a particular customer and a particular set of graph parameters can be generated from the call graph information from the first call graph and a second set of call graph parameters values for the particular customer and the particular set of graph parameters can be generated from the call graph information from the second call graph.

In step 804, for each graph parameter included in the set of graph parameters, determine a corresponding graph parameter value for the particular customer (e.g., determine OD1, PP1, SV1, CC1) using the first set of call data (e.g., the first call graph).

In step 806, for each graph parameter included in the set of graph parameters, determine a corresponding graph parameter value for the particular customer (e.g., determine OD2, PP2, SV2, CC2) using the second set of call data (e.g., the second call graph). In step 808, a churn score (CS) is determined using the graph parameter values determined in step 804 and 806. For example, in step 808 CS is determined using the an equation of the form:

CS=a0+a1(CC2−CC1)+a2(OD2−OD1)+a3(PP2−PP1)+a4(SV2−SV1),

Where a0, a1, a2, a3, and a4 are constants. In some embodiments, CS is determined using this equation:

CS=−4.718+2.267(CC2−CC1)−0.510(OD2−OD1)+1.546(PP2−PP1)−1.22(SV2−SV1)

In step 810, the customer is categorized based on the churn score (see above discussion of step 710).

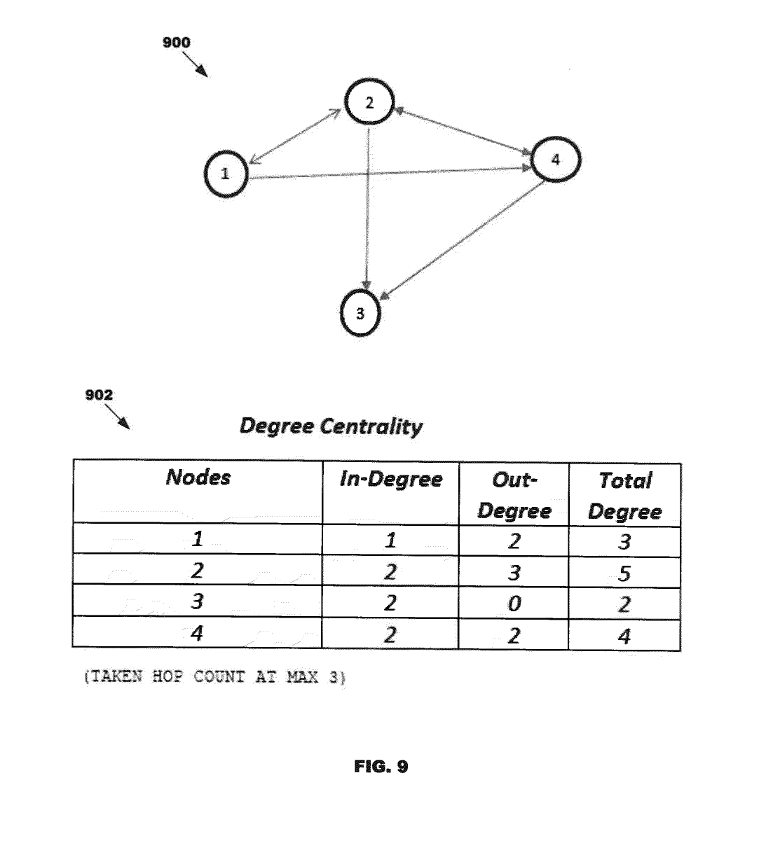

Referring now to FIG. 9, FIG. 9 illustrates an example call graph 900 and degree centrality table 902 created based on the information contained in call graph 900. FIG. 9 shall be used to illustrate how to determine a customer's initial influence score.

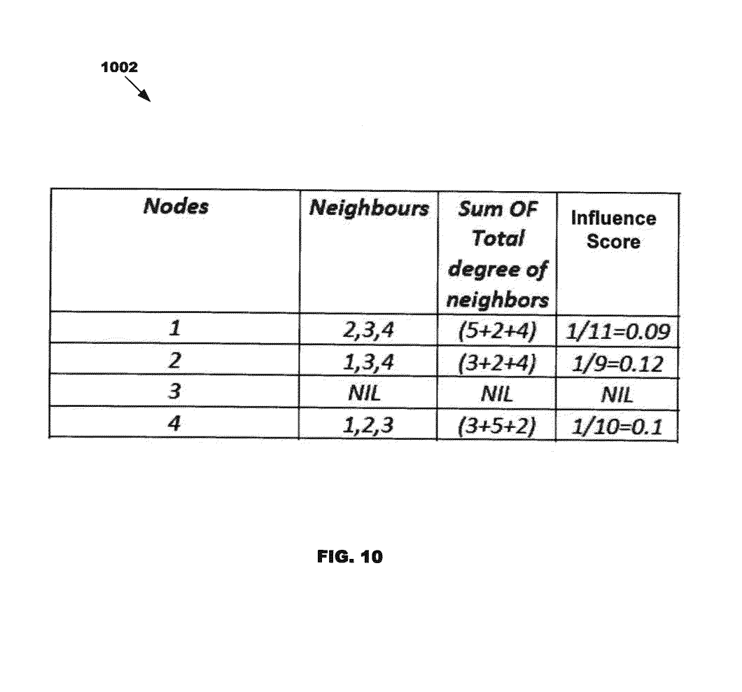

As illustrated in FIG. 9, a first step in determining the customer's influence value is to create a call graph (see call graph 900 for an example) (each node of the call graph represents a user of the network). As described above, call graphs can be created from CDRs. Once the call graph is created, then it is possible to create a degree centrality table (see table 902 for an example). The degree centrality table 902, for each customer represented in call graph 900, identifies the customer's in-degree centrality parameter value, out-degree centrality parameter value, and total degree value (i.e., out-degree+in-degree). The next step is to determine, for each customer, the customer's that are neighbours of the customer. Using Dijistras algorithm and maximum hop count of three: customer 1 is neighbours with customers 2, 3, 4; customer 2 is neighbours with customers 1, 3, 4; customer 3 has no neighbours; customer 4 is neighbours with customers 1, 2, 3. Next, for each customer, the sum of the neighbors' total degree value is determined. For example, for customer 1, customer 2's total degree value (5), customer 3's total degree value (2), and customer 4's total degree value (4) are summed to produce a total value of 11 (i.e., 5+2+4). Lastly, the inverse of this total value (e.g., 1/11) is determined to arrive at an influence score. This is illustrated in table 1002 shown in FIG. 10.

In some embodiments, the total value for the customer is summed with a value identifying how many neighbours the customer has to produce a final value and then the inverse of the final value is determined to arrive at the influence score. For example, considering customer 1, as shown above, customer 1's total score is 11, thus its final score is 14 (11+3) since customer 1 has three neighbours. Accordingly, in the alternative embodiments, customer 1's influence score is 1/14.

The above method determines the influence of a given customer based on the influence exerted by the neighbours of the given customer. The influence exerted by a neighbour of the given customer is determined based on the degree centrality of the neighbour. For instance, if a particular customer has neighbours with a high degree centrality score, this implies that the particular customer has strong influence over the network. Thus, a message passed by the particular customer (e.g., a text message, posting, e-mail from the customer) may spread throughout the network.

In the above example, even though node 3 (i.e., customer 3) has received calls/messages using the network, it has not sent any messages or made any calls. Thus, customer 3 is not influential and we consider node 3 as having no neighbours. Thus, customer 3 has an influence score of zero 0.

The below table contains example pseudo-code for illustrating an embodiment for determining the influence value for a customer.

TABLE 3
Psuedo code

```
Program: Computing SV by running a game.
Input: Graph Network ingested from CDR.
Output: SVs of all nodes in network
foreach node v in Network do
  DistanceVector D = Dijkstra(V,Network);
  kNeighbours(V) = Null;
  kDegrees(V) = 0;
  foreach node uε v in Network do
    if D(u) <= k then
      kNeighbours(V).push(u);
      kDegrees(V)++;
    end
end
foreach node v in Network do
  ShapleyValue[V] = 1
    1+kDegrees(v) ;
    foreach node u in kNeighbours(v) do
      ShapleyValue[V] += 1
      1+kDegrees(u) ;
    end
  end
  return Shapleyvalue;
end
```

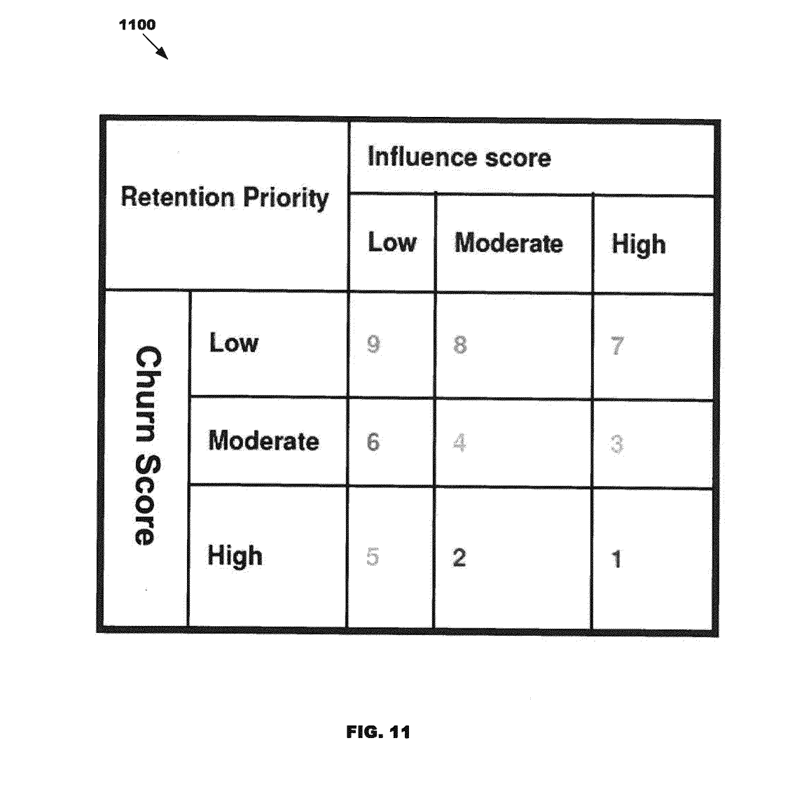

FIG. 11 shows a ranking matrix 1100 that may be used, in some embodiments, to rank a customer based on the customer's churn score and influence score. In the example shown, each churn score and each influence score is categorized as one of: low, moderate, and high. As also shown, each possible churn score and influence score tuple is associated with a rank value. For example, the tuple [churn score=low, influence score=low] is associated with a rank value of

9. As further examples, the tuple [churn score=high, influence score=high] is associated with a rank value of 1 and the tuple [churn score=moderate, influence score=low] is associated with a rank value of 6. Once the customers are ranked using, for example, the ranking matrix 1100, a business decision can be made as to which customers should be offered an incentive to stay in the network. For example, if budget constraints are high, then it might make sense to offer the incentive only to those customers having the highest rank (which in this example are the customer's having a rank value of 1)—i.e., the customers that are most likely to churn and have the highest influence.

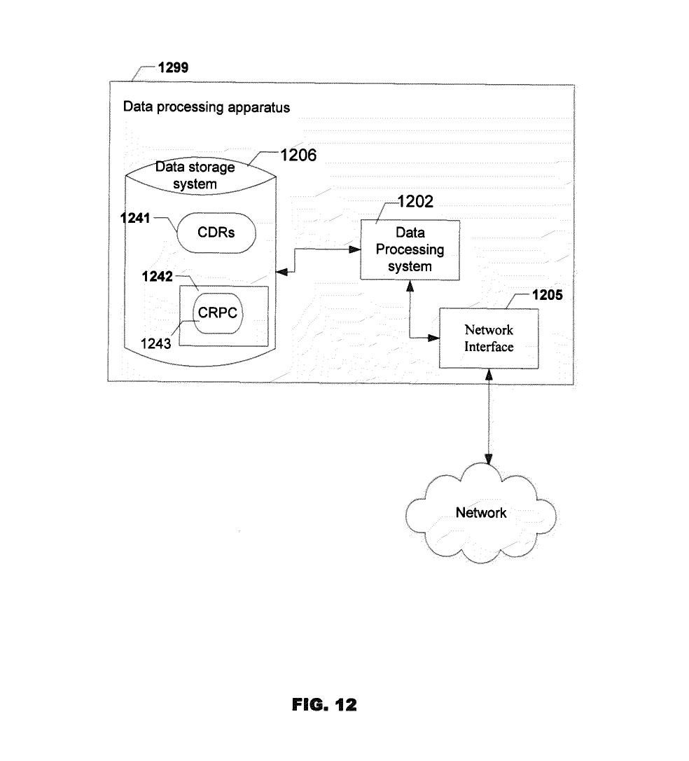

Referring now to FIG. 12, FIG. 12 illustrates a block diagram of a data processing apparatus 1299 according to some embodiments. As shown in FIG. 12, the data processing apparatus 1299 may include: a data processing system 1202, which may include one or more data processing devices each having one or more microprocessors and/or one or more circuits, such as an application specific integrated circuit (ASIC), Field-programmable gate arrays (FPGAs), etc; a network interface 1205 for connecting the apparatus 1299 to a network; a data storage system 1206, which may include one or more computer-readable mediums, such as non-volatile storage devices and/or volatile storage devices (e.g., random access memory (RAM). As shown, data storage system 1206 may store a large set of CDRs 1241.

In embodiments where data processing system 1202 includes a processor (e.g., a microprocessor), a computer program product is provided, which computer program product includes: computer readable program code 1243, which implements a computer program, stored on a computer readable medium 1242, such as, but not limited, to magnetic media (e.g., a hard disk), optical media (e.g., a DVD), memory devices (e.g., random access memory), etc. In some embodiments, computer readable program code 1243 is configured such that, when executed by data processing system 1202, code 1243 causes the processing system 1202 to perform steps described above (e.g., steps describe above with reference to the flow charts shown in the drawings).

In other embodiments, the apparatus 1299 may be configured to perform steps described above without the need for code 1243. For example, data processing system 1202 may consist merely of specialized hardware, such as one or more application-specific integrated circuits (ASICs). Hence, the features of the present invention described above may be implemented in hardware and/or software. For example, in some embodiments, the functional components of the apparatus described above may be implemented by data processing system 1202 executing computer instructions 1243, by data processing system 1202 operating independent of any computer instructions 1243, or by any suitable combination of hardware and/or software.

While various embodiments of the present invention have been described above, it should be understood that they have been presented by way of example only, and not limitation. Thus, the breadth and scope of the present invention should not be limited by any of the above-described exemplary embodiments. Moreover, any combination of the above-described elements in all possible variations thereof is encompassed by the invention unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. In system comprising a network operated by or for a network operator, a method for ranking a customer based on the customer's estimated influence in the network, comprising:
determining a churn score for a first customer of the network operator, wherein the churn score is a value corresponding to a probability of the first customer churning out of the network;
determining an influence score for the first customer, wherein the influence score is a value representing an estimated influence exerted by the first customer on one or more other customers of the network operator; and
assigning a rank to the first customer based on the determined influence score and the determined churn score.

2. The method of claim 1, wherein
the method further comprises determining an influence score for one or more neighbors of the first customer; and
the step of determining the churn score for the first customer comprises: determining an initial churn score for the first customer and adjusting the initial churn score based on the influence scores for the one or more neighbors.

3. The method of claim 2, wherein the step of adjusting the initial churn score based on the influence scores for the one or more neighbors comprises:
determining if the influence score for a neighbor of the first customer exceeds a first threshold; and
in response to determining that the influence score for the neighbor of the first customer exceeds the first threshold, adjusting the first customer's initial churn score.

4. The method of claim 1, wherein
the method further comprises determining whether the customer had a neighbor that recently churned out of the network, and
the step of determining the churn score for the first customer comprises: determining an initial churn score for the first customer and adjusting the initial churn score in consequence of determining that the customer had a neighbor that recently churned out of the network.

5. The method of claim 1, wherein the step of determining the churn score for the first customer comprises:
obtaining first call data for the first customer;
using the first call data to determine a value (v1) for a graph parameter for the first customer, the graph parameter being one of: (a) an out-degree parameter, (b) a Shapley Value parameter, (c) a proximity prestige parameter, and (d) closeness centrality parameter; and
using the determined value (v1) to determine the churn score.

6. The method of claim 5, wherein the step of determining the churn score for the first customer further comprises:
obtaining second call data for the first customer, the second call data identifying communications from the first customer that were made during a second period of time, wherein the first call data for the first customer identifies communications from the first customer that were made during a first period of time;
using the second call data to determine a value (v2) for the graph parameter; and
using the determined values v1 and v2 to determine the churn score.

7. The method of claim 6, wherein the step of using the determined values v1 and v2 to determine the churn score comprises calculating c1*(v2−v1), wherein c1 is a predetermined constant.

8. The method of claim 1, wherein the step of determining the influence score for the first customer comprises:
determining an initial influence score for the first customer;
determining whether the first customer is a potential spreader; and
adjusting the initial influence score in consequence of determining that the first customer is a potential spreader.

9. The method of claim 1, further comprising:
determining whether the rank assigned to the first customer exceeds a rank threshold; and
in consequence of determining that the rank assigned to the first customer exceeds the rank threshold, taking an action to reduce the probability that the first customer will churn out of the network within a period of time.

10. The method of claim 9, wherein the step of taking an action to reduce the probability comprises offering to the first customer an incentive for the first customer to remain a customer of the network operator at least during the period of time.

11. A data processing apparatus, the data processing apparatus being configured to:
determine a churn score for a first customer of the network operator, wherein the churn score is a value corresponding to a probability of the first customer churning out of the network;
determine an influence score for the first customer, wherein the influence score is a value representing an estimated influence exerted by the first customer on one or more other customers of the network operator; and
assign a rank to the first customer based on the determined influence score and the determined churn score.

12. The data processing apparatus of claim 11, wherein
the data processing apparatus is further configured to determine an influence score for one or more neighbors of the first customer; and
the data processing apparatus is configured to determine the churn score for the first customer by performing a process comprising: determining an initial churn score for the first customer and adjusting the initial churn score based on the influence scores for the one or more neighbors.

13. The data processing apparatus of claim 12, wherein
the data processing apparatus is configured to adjust the initial churn score based on the influence scores for the one or more neighbors by performing a process comprising:
determining if the influence score for a neighbor of the first customer exceeds a first threshold; and
in response to determining that the influence score for the neighbor of the first customer exceeds the first threshold, adjusting the first customer's initial churn score.

14. The data processing apparatus of claim 11, wherein
the data processing apparatus is further configured to determine whether the first customer had a neighbor that recently churned out of the network, and
the data processing apparatus is configured to determine the churn score for the first customer by performing a process comprising: determining an initial churn score for the first customer and adjusting the initial churn score in consequence of determining that the customer had a neighbor that recently churned out of the network.

15. The data processing apparatus of claim 11, wherein
the data processing apparatus is configured to determine the churn score for the first customer by performing a process comprising:
obtaining first call data for the first customer;
using the first call data to determine a value (v1) for a graph parameter for the first customer, the graph parameter being one of: (a) an out-degree parameter, (b) a Shapley Value parameter, (c) a proximity prestige parameter, and (d) closeness centrality parameter; and
obtaining second call data for the first customer, the second call data identifying communications from the first customer that were made during a second period of time, wherein the first call data for the first customer identifies communications from the first customer that were made during a first period of time;
using the second call data to determine a value (v2) for the graph parameter; and
using the determined values v1 and v2 to determine the churn score.

16. The data processing apparatus of claim 15, wherein the step of using the determined values v1 and v2 to determine the churn score comprises calculating c1*(v2−v1), wherein c1 is a predetermined constant.

17. The data processing apparatus of claim 11, wherein
the data processing apparatus is configured to determine the influence score for the first customer by performing a process comprising:
determining an initial influence score for the first customer;
determining whether the first customer is a potential spreader; and
adjusting the initial influence score in consequence of determining that the first customer is a potential spreader.

18. The data processing apparatus of claim 11, wherein the data processing apparatus is further configured to:
determine whether the rank assigned to the first customer exceeds a rank threshold; and
in consequence of determining that the rank assigned to the first customer exceeds the rank threshold, provide information indicating that an action to reduce the probability that the first customer will churn out of the network should be taken.

19. A computer program product comprising a non-transitory computer readable medium storing a computer code, the computer code comprising:
computer code for determining a churn score for a first customer of the network operator, wherein the churn score is a value corresponding to a probability of the first customer churning out of the network;
computer code for determining an influence score for the first customer, wherein the influence score is a value representing an estimated influence exerted by the first customer on one or more other customers of the network operator; and
computer code for assigning a rank to the first customer based on the determined influence score and the determined churn score.

20. The computer program product of claim 19, wherein
the computer code further comprises computer code for determining an influence score for one or more neighbors of the first customer; and
the computer code for determining the churn score for the first customer comprises: computer code for determining an initial churn score for the first customer and computer code for adjusting the initial churn score based on the influence scores for the one or more neighbors.

21. The computer program product of claim 20, wherein
the computer code further comprises computer code for determining whether the customer had a neighbor that recently churned out of the network, and
the computer code for determining the churn score for the first customer comprises: computer code for determining an initial churn score for the first customer and computer code for adjusting the initial churn score in consequence of determining that the customer had a neighbor that recently churned out of the network.
